(19) United States
(12) Patent Application Publication
(10) Pub. No.: US 2009/0282914 A1
(43) Pub. Date: Nov. 19, 2009

(54) Acceleration sensor having a surrounding seismic mass

(76) Inventor: Dirk Rehle, Heilbronn (DE)

Correspondence Address: KENYON & KENYON LLP, ONE BROADWAY, NEW YORK, NY, 10004, US

(21) Appl. No.: 12/386,612

(22) Filed: Apr. 20, 2009

(30) Foreign Application Priority Data
May 19, 2008 (DE) 10 2008 001 863.5

(51) Int. Cl. G01C 19/56; G01P 15/125

(52) U.S. Cl. 73/504.12; 73/514.32

(57) ABSTRACT

A micromechanical acceleration sensor has a substrate, a suspension, a seismic mass, and stationary capacitive electrodes, which seismic mass is suspended over the substrate with the aid of the suspension. The seismic mass has a mass center of gravity, and the suspension has at least two anchors on the substrate, the at least two anchors being situated next to the mass center of gravity at a distance which is small compared to a horizontal extension of the seismic mass. The stationary capacitive electrodes are provided in recesses of the seismic mass. The seismic mass directly surrounds the suspension.

### BACKGROUND OF THE INVENTION

1. Field of the Invention

The present invention relates to a micromechanical acceleration sensor having a substrate, a suspension, a seismic mass, and stationary capacitive electrodes, which seismic mass is suspended over the substrate with the help of the suspension.

2. Description of Related Art

A sensor of the type described above is disclosed in German Patent Application document DE 10 2007 047 592, which is not deemed to be a prior publication with respect to the present application. The movable electrodes are situated here on the internal edge of the seismic mass. The stationary capacitive electrodes are situated with the help of shared suspension bars directly in the vicinity of the central suspension bar of the seismic mass.

If the substrate is made of a material that is different from that of the seismic mass and its suspension, mechanical stresses between the substrate and the suspension or the seismic mass may occur due to different thermal expansion coefficients. Stresses of this type may, however, also occur because the suspension or the seismic mass were manufactured already having internal stresses. In addition, mechanical stresses may be caused in the substrate itself due to the manufacturing process, for example, by soldering or gluing, or capping. Since the suspension and the seismic mass are much weaker elements compared with the substrate, these stresses are dissipated due to the deformation of the suspension and the seismic mass. The position of the seismic mass with respect to the substrate and other fixed elements attached to the substrate is thus modified. For example, in the case of capacitive acceleration sensors, a zero point error occurs for the measured capacitance due to a change in the distance of the mobile electrodes to the fixed electrodes.

Published German Patent DE 196 39 946 shows a micromechanical acceleration sensor having a surface-micromechanical structure having two suspension points next to each other, with a movable seismic mass between them, which is suspended on the two suspension points with the aid of suspension springs.

Published German patent application document DE 19523895 shows a micromechanical yaw rate sensor having a surface-micromechanical structure having a central suspension (a central suspension point) having a seismic mass situated around it, which is suspended on the central suspension with the aid of suspension springs.

Published German patent application document DE 19500800 shows, in FIGS. 5 and 6, a micromechanical sensor having a central suspension and two seismic masses situated opposite each other next to it, the seismic masses being connected with the aid of connecting bars and suspended on the central suspension.

Published European patent application document EP 1083144 shows a micromechanical device having a central suspension and two seismic masses situated opposite each other next to it, the seismic masses being connected with the aid of connecting bars and suspended on the central suspension with the aid of a connecting beam. The central suspension is situated in the center (on the central axis of the surface center of gravity or mass center of gravity) of the entire movable structure.

Published European patent application document EP 1626283 shows a micromechanical device having a central suspension and two seismic masses situated opposite each other next to it, the seismic masses being connected with the aid of connecting bars and suspended on the central suspension with the aid of a connecting beam. The central suspension is situated in the center (on the central axis) of the entire movable structure. Furthermore, a plurality of movable electrodes and also a plurality of fixed electrodes on the movable structure are disclosed. The plurality of fixed electrodes has a shared suspension, which is situated in the proximity of the central suspension. Patent Application DE 10 2006 033 636 A1 shows a similar object.

Published International patent application document WO/2004010150 shows a micromechanical acceleration sensor having a central suspension and an annular seismic mass, as well as movable electrodes designed as fingers on the internal periphery of the annular seismic mass.

### BRIEF SUMMARY OF THE INVENTION

The present invention provides a micromechanical acceleration sensor having a substrate, a suspension, a seismic mass, and stationary capacitive electrodes. The seismic mass is suspended over the substrate with the help of the suspension. The seismic mass has a mass center of gravity, and the suspension has at least two anchors on the substrate, the at least two anchors being situated next to the center of gravity at a distance which is small compared to a horizontal extension of the seismic mass. The stationary capacitive electrodes are provided in recesses of the seismic mass. In accordance with the present invention, the seismic mass directly surrounds the suspension. The seismic mass is at a distance from the suspension in such a way that the desired mobility of the seismic mass is enabled. No other active element is situated between an internal edge area of the seismic mass and the suspension.

An example embodiment of the present invention provides that the sensor is designed as a linear acceleration sensor having at least one measuring axis. The suspension is advantageously designed as a beam in whose longitudinal direction the measuring axis is situated. It is also advantageous that the seismic mass surrounds the suspension in the shape of a closed ring. The seismic mass may thus be designed to be particularly sturdy against deformations. It is advantageous that the recesses have the shape of a closed ring. The recesses, whose edge areas form mobile capacitive electrodes, are thus particularly sturdy against deformations. The capacitive electrodes are advantageously provided individually anchored on the substrate. One advantageous embodiment of the present invention provides that two electrodes are situated in each recess. Capacitor structures which are properly shielded outward may thus be advantageously created between the corresponding electrode and the edge area of the recess opposite thereto. An example embodiment of the present invention provides that one electrode is situated in each recess. This arrangement is compact, so that advantageously smaller and thus more recesses are provided in the seismic mass, which increases the displayable capacitance and thus the measuring accuracy of the sensor.

### BRIEF DESCRIPTION OF SEVERAL VIEWS OF THE DRAWING

FIG. 1 shows an example acceleration sensor.

FIG. 2 shows another example acceleration sensor.

FIG. 3 schematically shows a first exemplary embodiment of an acceleration sensor according to the present invention having a surrounding seismic mass.

FIG. 4 schematically shows a second exemplary embodiment of an acceleration sensor according to the present invention having a surrounding seismic mass.

### DETAILED DESCRIPTION OF THE INVENTION

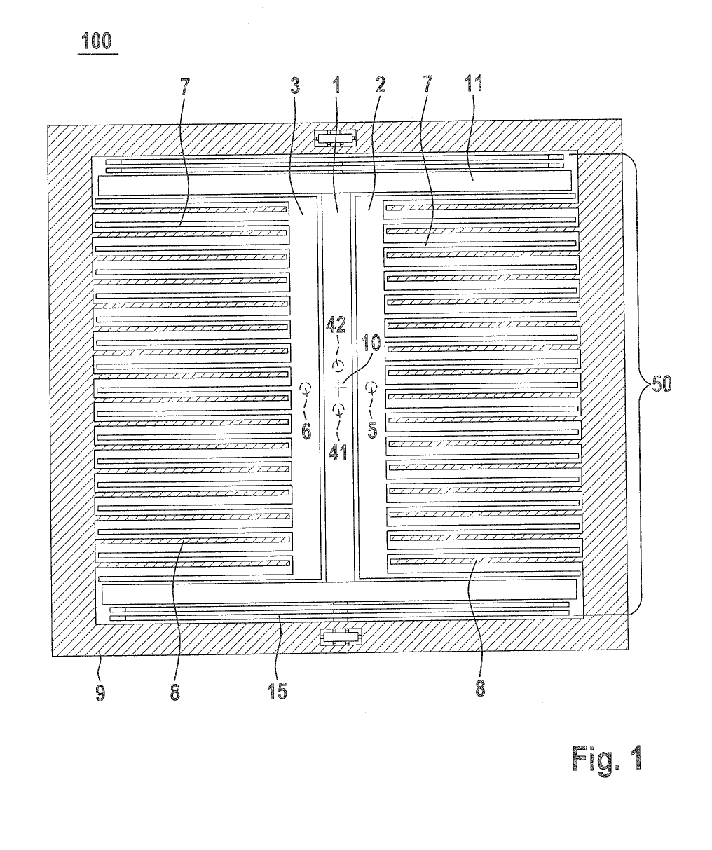

FIG. 1 shows an acceleration sensor as described in German patent application document DE 10 2007 047 592, which is not deemed to be a prior publication with respect to the present application. The acceleration sensor has a substrate 100, a seismic mass 9, a suspension 50 having two anchors 41 and 42 near the center, a suspension beam 1, and spring elements 15. Mass center of gravity 10 (also often referred to as the surface center of gravity or also the central axis) of seismic mass 9, or its projection in top view, runs through suspension beam 1. The two anchors 41 and 42 are not situated on mass center of gravity 10, but at a short distance adjacent thereto. They are situated under the suspension beam and are therefore illustrated by a dashed line. The two anchors 41 and 42 anchor suspension beam 1 on substrate 100. In the acceleration sensor illustrated, mass center of gravity 10 is located between anchors 41 and 42. Cross beams 11 and thereon, in turn, spring elements 15 in the form of typical folded springs, which elastically suspend annular seismic mass 9, are provided on both outer ends of suspension beam 1. Spring elements 15 make it possible for seismic mass 9 to move in a measuring axis which runs along the direction of the greatest extension of suspension beam 1. On two opposite sides of suspension beam 1, additional suspension beams 2 and 3 are provided, which carry stationary capacitive electrodes 7. The additional suspension beams 2 and 3 are each anchored on the substrate in the proximity of mass center of gravity 10 using anchors 5 and 6. Movable capacitive electrodes 8, which form capacitor structures together with stationary electrodes 7, are situated opposite stationary capacitive electrodes 7. Movable capacitive electrodes 8 are formed from comb-like formations of seismic mass 9, which extend from an internal edge of seismic mass 9 to suspension beam 1. Stationary electrodes 7 and movable electrodes 8 form intermeshed comb structures.

Seismic mass 9 and movable capacitive electrodes 8 are perforated, i.e., have a regular arrangement of through holes. The perforation makes it possible for an etching medium to penetrate to a sacrificial layer thereunder during an etching process when the sensor is manufactured, so that seismic mass 9 and movable capacitive electrodes 8 are reliably separated from substrate 100 and thus made movable. Fixed capacitive electrodes 7 and bars 1, 2, 3 may also be perforated.

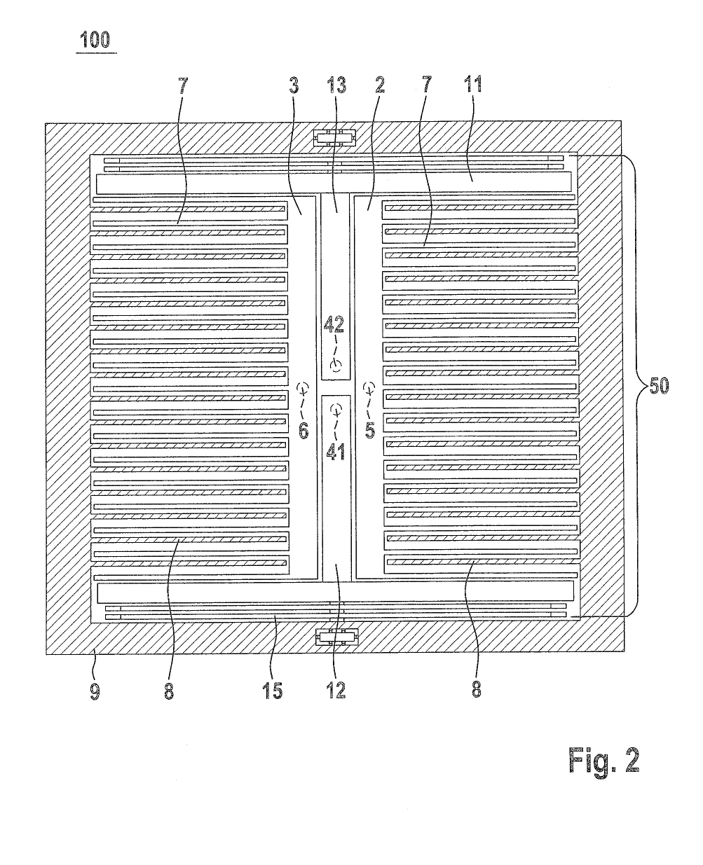

FIG. 2 shows another acceleration sensor as described in German patent application document DE 10 2007 047 592, which is not deemed to be a prior publication with respect to the present application. The acceleration sensor has a suspension 50 having two anchors 41 and 42 near the center and, unlike the object of FIG. 1, a split suspension beam 12, 13 having spring elements 15. Each part of split suspension beam 12, 13 is anchored on a substrate thereunder, shared by all elements, with the aid of one of two anchors 41 and 42. Spring elements 15 in the form of typical folded springs, which elastically suspend an annular seismic mass 9, are provided on both outer ends of split suspension beam 12, 13. Spring elements 15 make it possible for seismic mass 9 to move in a measuring axis which runs along the direction of the greatest extension of suspension beam 12,13.

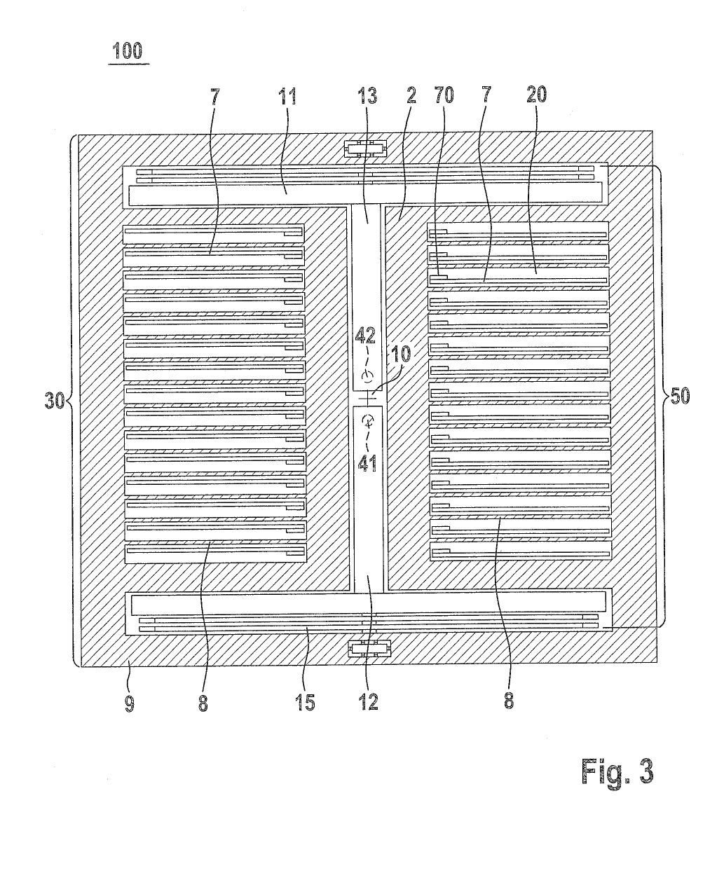

FIG. 3 schematically shows a first exemplary embodiment of an acceleration sensor according to the present invention having a surrounding seismic mass. The figure shows a micromechanical acceleration sensor having a substrate, a suspension 50, a seismic mass 9, and stationary capacitive electrodes 7. Seismic mass 9 is suspended over substrate 100 with the help of suspension 50. The seismic mass has a mass center of gravity 10. Suspension 50 has at least two anchors 41 and 42 on substrate 100. The at least two anchors 41 and 42 are situated in close proximity of mass center of gravity 10. In close proximity means that each of the two anchors 41 and 42 is situated at a distance next to mass center of gravity 10 which is small compared to the total horizontal extension 30 of seismic mass 9 or also the total horizontal extension of suspension 50 over substrate 100. Seismic mass 9 directly surrounds suspension 50. Seismic mass 9 has recesses 20 in the shape of closed rings, in which stationary capacitive electrodes 7 are situated. The acceleration sensor in this exemplary embodiment has a suspension 50 having two anchors 41 and 42 near the center and a split suspension beam 12, 13 having spring elements 15, like the object which is illustrated in FIG. 1 and elucidated. Spring elements 15 in the form of typical folded springs, which elastically suspend an annular seismic mass 9, are provided on both outer ends of split suspension beam 12, 13. For this purpose, spring elements 15 are connected, in a first area, to a cross beam 11, which in turn is situated at one end of suspension beam 12 or 13. In a second area, spring elements 15 are connected to seismic mass 9. Unlike the object of FIG. 1, seismic mass 9 directly surrounds suspension 50, i.e., it surrounds split suspension beam 12, 13 having cross beams 11 and spring elements 15. Seismic mass 9 is at a distance from suspension 50 in such a way that the desired mobility of seismic mass 9 is enabled. However, no other active element is situated between an internal edge area of seismic mass 9 and suspension 50. Seismic mass 9 has recesses 20, in each of which one stationary capacitive electrode 7 is situated, which is anchored to substrate 100 with the aid of an anchor 70. Stationary capacitive electrode 7 is situated opposite and near an edge area of recess 20. The edge area functions as a movable electrode 8 and forms, together with stationary capacitive electrode 7, a capacitor structure.

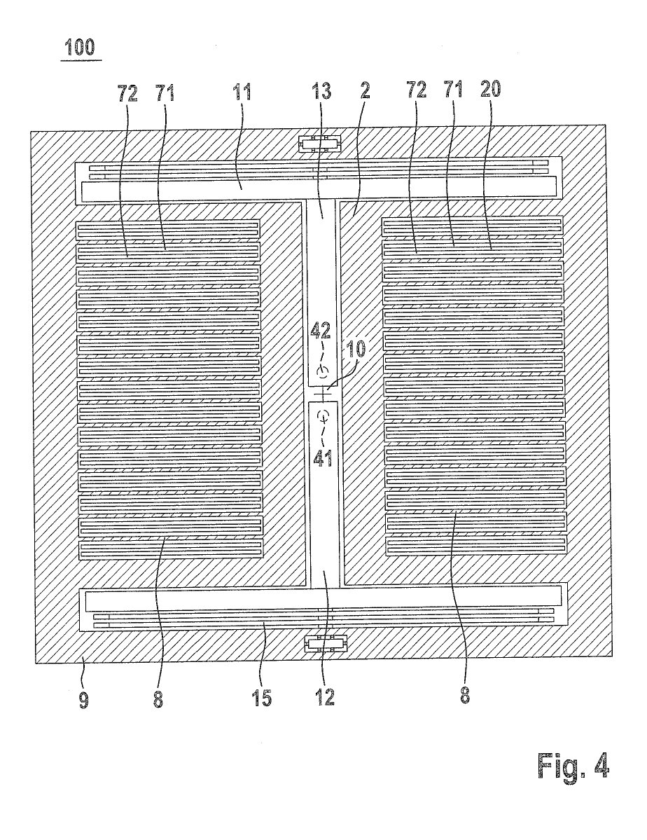

FIG. 4 schematically shows a second exemplary embodiment of an acceleration sensor according to the present invention having a surrounding seismic mass. Unlike the first exemplary embodiment according to FIG. 3, seismic mass 9 has recesses 20 in the shape of closed rings, in each of which two stationary capacitive electrodes 71, 72, which are anchored to substrate 100, are situated. Each stationary capacitive electrode 71, 72 is situated opposite an edge area of a recess 20, the edge area functioning as a mobile electrode 8 and forming, together with stationary capacitive electrode 71 or 72, a capacitor structure.

The features of the illustrated and described exemplary embodiments may be combined with each other according to the present invention.

What is claimed is:

1. A micromechanical acceleration sensor, comprising:
a substrate;
a suspension having at least two anchors on the substrate;
a seismic mass suspended over the substrate with the aid of the suspension, wherein the seismic mass has a mass center of gravity and the seismic mass directly surrounds the suspension, and wherein the at least two anchors of the suspension being situated next to the mass center of gravity of the seismic mass at a distance which is substantially smaller compared to a horizontal extension of the seismic mass; and
multiple stationary capacitive electrodes provided in recesses of the seismic mass.

2. The micromechanical acceleration sensor as recited in claim 1, wherein the sensor is a linear acceleration sensor provided with at least one measuring axis.

3. The micromechanical acceleration sensor as recited in claim 2, wherein the seismic mass surrounds the suspension in the shape of a closed ring.

4. The micromechanical acceleration sensor as recited in claim 2, wherein the recesses have the shape of a closed ring.

5. The micromechanical acceleration sensor as recited in claim 3, wherein the suspension has at least one suspension beam.

6. The micromechanical acceleration sensor as recited in claim 3, wherein a spring element is situated on at least one end of the suspension beam, wherein a first area of the spring element is connected to the suspension beam and a second area of the spring element is connected to the seismic mass.

7. The micromechanical acceleration sensor as recited in claim 3, wherein two stationary capacitive electrodes are situated in each recess.

8. The micromechanical acceleration sensor as recited in claim 3, wherein one stationary capacitive electrode is situated in each corresponding recess.

9. The micromechanical acceleration sensor as recited in claim 3, wherein the stationary capacitive electrodes are individually anchored on the substrate.
